(19) United States
(12) Patent Application Publication
(10) Pub. No.: US 2014/0050456 A1
(43) Pub. Date: Feb. 20, 2014

(54) ELECTRONIC DISPLAY DEVICE

(71) Applicant: Primax Electronics Ltd., Neihu (TW)

(72) Inventor: Tzu-Hung Cheng, Taipei (TW)

(73) Assignee: Primax Electronics Ltd., Neihu (TW)

(21) Appl. No.: 14/063,618

(22) Filed: Oct. 25, 2013

Related U.S. Application Data
(63) Continuation-in-part of application No. 13/207,707, filed on Aug. 11, 2011.

(30) Foreign Application Priority Data
Jun. 3, 2011 (TW) 100119527

(51) Int. Cl. H04N 9/87

(52) U.S. Cl. CPC H04N 9/87
USPC 386/230

(57) ABSTRACT

For evaluating an image file in a social website through an image player, on which the image file is also shown, the image player automatically issues a wireless connection signal to a handheld electronic device in the vicinity of the image player. The image player automatically transmits the image file to the handheld electronic device in a wireless transmission manner after the connection is successfully established. The handheld electronic device transmits an evaluation message regarding the image file to the image player. The image player automatically executes a transfer program to transfer the evaluation message to the social website.

### CROSS-REFERENCE TO RELATED APPLICATION

This application is a continuation-in-part application of U.S. patent application Ser. No. 13/207,707, filed Aug. 11, 2011, the contents of which are incorporated herein for reference.

### FIELD OF THE INVENTION

The present invention relates to an electronic display device, and more particularly to an image player accessible to a social website. The present invention also relates to a method for evaluating an image file in a social website through an image player.

### BACKGROUND OF THE INVENTION

With increasing development of science and technology, an electronic display device such as an image player has become a very popular consumer electronic device. The image player functions for revealing images in front of people. Generally, the images, for example, may be still image files (e.g. photos) or video files (e.g. movies) or both. The image player, for example, may be a TV set, a computer screen, a digital photo frame or a digital signage.

Hereinafter, the configurations of a conventional image player will be illustrated with reference to FIGS. 1 and 2. FIG. 1 is a schematic perspective view illustrating the outward appearance of a conventional image player. FIG. 2 is a schematic perspective view illustrating the outward appearance of the conventional image player of FIG. 1 and taken along another viewpoint. For example, the conventional image player 1 shown in FIGS. 1 and 2 is a digital photo frame. The conventional image player 1 comprises a display screen 10, a storage medium 11 and a connecting slot 12. The storage medium 11 is disposed within the image player 1 for storing at least one image file P1. The display screen 10 is disposed on a surface 13 of the image player 1. The display screen 10 is in communication with the storage medium 11 for showing the stored image file P1. The connecting slot 12 is located at a sidewall 14 of the image player 1. When a memory card 15 is inserted into the connecting slot 12, the memory card 15 can be accommodated within the connecting slot 12. The memory card 15 is used for storing the image file P1. Since the memory capacity of the storage medium 11 is limited, the connecting slot 12 is usually a necessary component of the image player 1 for accommodating the memory card 15. By means of the above configurations, the image player 1 is capable of showing the image file P1.

Recently, as the science and technology are increasingly developed, more and more computer users utilize social websites to communicate with each other. The computer users join the social websites one after another to upload the image file P1 to the social websites. Consequently, other computer users can watch and evaluate the image file P1. In a case that the image file P1 is positively evaluated by so many other computer users, it means that the image file P1 win recognition by the public. Moreover, the image file P1 may be shown through the memory card and the image player 1. However, this way of showing the image file P1 is very troublesome. For solving the above drawbacks, a network-enabled image player is disclosed.

FIG. 3 schematically illustrates a conventional network-enabled image player in communication with a social website. The network-enabled image player 2 comprises a display screen 20, a storage medium 21 and a network module 23. The relationships between the display screen 20, the storage medium 21 and the connecting slot are similar to those of the conventional image player 1 as shown in FIGS. 1 and 2, and are not redundantly described herein. The network module 23 is disposed within the image player 2 and connected with the storage medium 21. When the network module 23 is in communication with a social website F, the image file P1 from the social website F may be received by the network module 23. The image file P1 is copied and then transmitted to the storage medium 21 through the network module 23. In such way, the network-enabled image player 2 is capable of playing the image file P1 via the display screen 20.

The network-enabled image player 2 is able to connect with the social website F and play the image file P1 that is stored in the social website F. Consequently, the image file P1 shown on the conventional image player 2 can be watched by the observers passing through the image player 2. However, the image player 2 still has some drawbacks. For example, since the network-enabled image player 2 only has the function of playing the image files, the observers passing through the image player 2 fail to give evaluation messages about the image file P1. Moreover, if the network-enabled image player 2 is used as a digital signage for offering advertisement, the observers passing through the image player 2 fail to give remarks about the image file P1. Therefore, there is a need of providing an image player capable of receiving the evaluation message.

### SUMMARY OF THE INVENTION

The present invention thus provides an image player capable of receiving and transferring an evaluation message of an image file to a social website.

The present invention also provides a method for evaluating an image in a social website through an image player by a handheld electronic device, which is in the vicinity of the image player without accessing to the social website.

In an aspect, the present invention provides an image player accessible to a social website. The image player includes a display screen, on which an image file revealed by the social website is shown; a wireless signal transmitter disposed within image player and automatically issuing a wireless connection signal to a handheld electronic device in the vicinity of the image player in order to establish a connection between the image player and the handheld electronic device, wherein the image file is transmitted from the wireless signal transmitter to the handheld electronic device in a wireless transmission manner provided that the connection is successfully established; a wireless signal receiver disposed within the image player for receiving an evaluation message regarding the image file from the handheld electronic device; and a transfer program installed in the image player, and automatically executed to transfer the evaluation message received from the handheld electronic device to the social website.

The image player may further comprise a built-in storage device or a removable storage device for storing the image file. The removable storage device may be a memory card or a memory device inserted in a connecting slot of the image player.

The image player may further comprise a built-in network module in communication with the storage device and accessible to the social website, wherein a copy of the image file revealed by the social website is duplicated and stored in the storage device. The built-in network module may be accessible to the social website in a 3G wireless network communication manner, a 4G wireless network communication manner, a wireless fidelity (Wi-Fi) communication manner, a general packet radio service (GPRS) communication manner or an Edge network communication manner.

In an embodiment, the wireless signal transmitter is a Bluetooth signal transmitter or a near field communication (NFC) signal transmitter, and the wireless signal receiver is a Bluetooth signal receiver or a near field communication (NFC) signal receiver.

In an embodiment, the image player receives an evaluation message regarding the image file from a handheld electronic device, which comprises: a storage device for storing the image file transmitted from the image player; a screen for showing the image file; an input module for inputting characters or symbols as the evaluation message; a wireless signal receiver for receiving the wireless connection signal from the image player; and a wireless signal transmitter for transmitting the evaluation message to the wireless signal receiver of the image player.

In an embodiment, the input module may be a physical keyboard arranged beside the screen, or an on-screen keyboard shown on the screen.

In an embodiment, when the wireless connection signal from the wireless signal transmitter is received by the handheld electronic device, a connection confirming interface is shown on the screen to optionally trigger the connection between the image player and the handheld electronic device. Preferably, the connection confirming interface comprises a yes option to be selectively activated for permitting the connection, and a no option to be selectively activated for refusing the connection.

In another aspect, the present invention provides a method for evaluating an image file in a social website through an image player, wherein the image file is also shown on a display screen of an image player. In the method according to the present invention, the image player automatically issues a wireless connection signal to a handheld electronic device in the vicinity of the image player. The image player automatically transmits the image file to the handheld electronic device in a wireless transmission manner after the connection is successfully established. The handheld electronic device transmits an evaluation message regarding the image file to the image player. The image player automatically executes a transfer program to transfer the evaluation message to the social website.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional image player;

FIG. 2 is a schematic perspective view illustrating the outward appearance of the conventional image player of FIG. 1 and taken along another viewpoint;

FIG. 3 schematically illustrates a conventional internet-enabled image player in communication with a social website;

FIG. 4 schematically illustrates an image player in communication with a social website according to an embodiment of the present invention;

FIG. 5 schematically illustrates the connection between the image player of the present invention and a handheld electronic device;

FIG. 6 schematically illustrates the handheld electronic device in communication with the image player according to an embodiment of the present invention; and

FIG. 7 schematically illustrates the contents of a connection confirming interface of the handheld electronic device in communication with the image player according to an embodiment of the present invention.

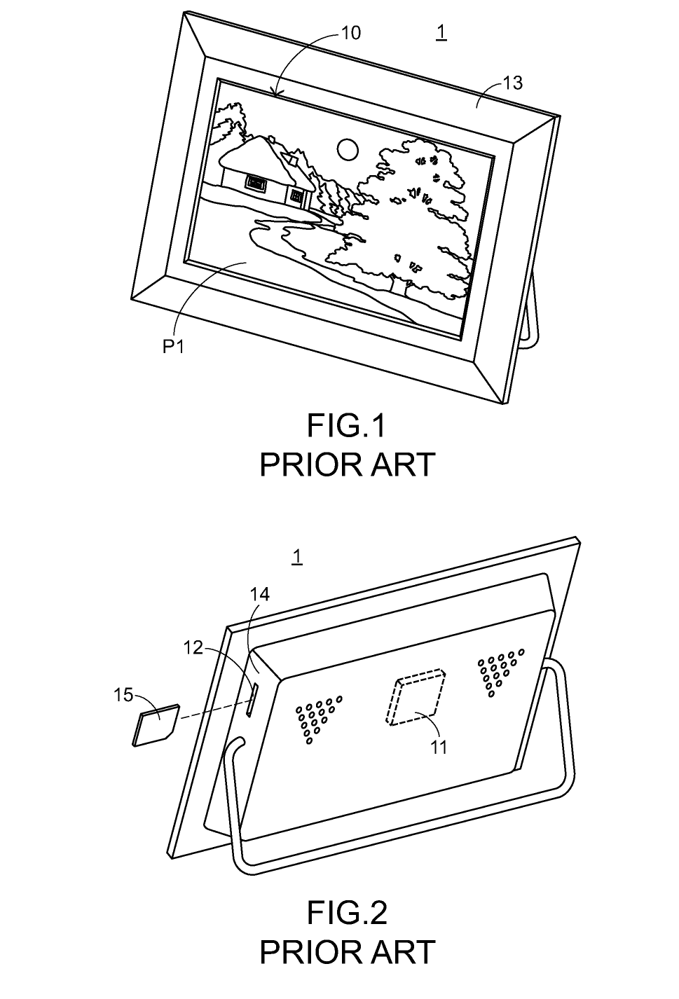

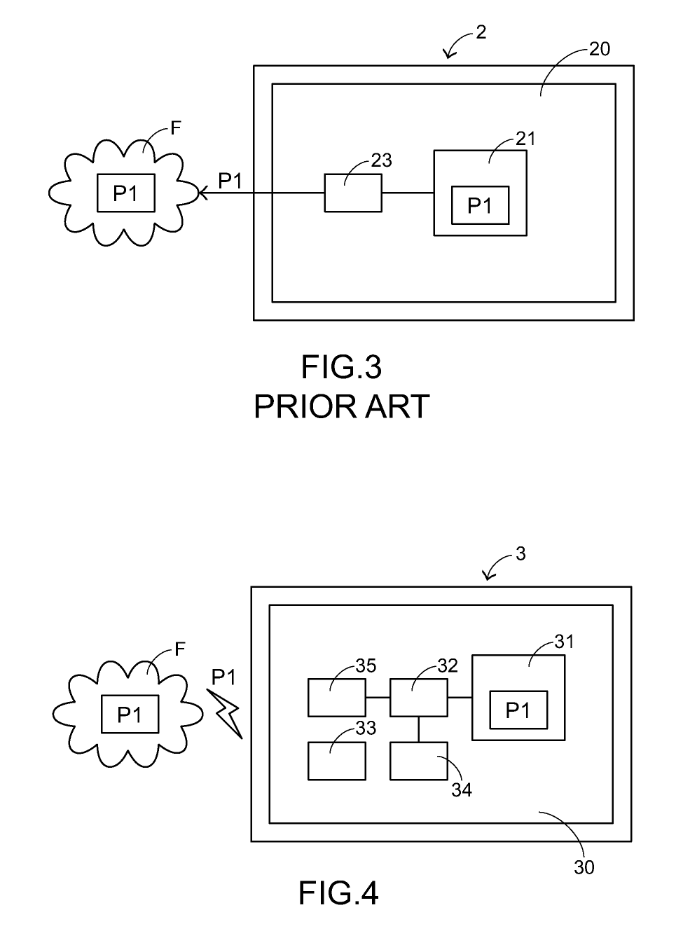

### DETAILED DESCRIPTION OF THE PREFERRED EMBODIMENT

For obviating the drawbacks encountered from the prior art, the present invention provides an image player. FIG. 4 schematically illustrates an image player accessible to a social website, for example via Internet, according to an embodiment of the present invention. As shown in FIG. 4, the image player 3 comprises a display screen 30, a storage device 31, a transfer program 32, a wireless signal transmitter 33, a wireless signal receiver 34 and a network module 35. The display screen 30 is disposed on a surface of the image player 3. The storage device 31 is disposed within the image player 3, e.g. a built-in storage device, for storing at least one image file P1. The image files comprise static electronic files (e.g. photos) and dynamic electronic files (e.g. movies). The stored image file P1 can be shown on the display screen 30. In this embodiment, the image player 3 is a digital photo frame. The storage device 31 is a storage medium, which is built-in the image player 3. In alternative embodiments, the image player 3 is an electronic signage, and the storage device 31 is a memory card or a removable storage device, which is externally and removably connected with a connecting slot of the image player 3. The transfer program 32 is installed in the image player 3. The wireless signal transmitter 33 and the wireless signal receiver 34 are disposed within or built in the image player 3.

Please refer to FIG. 4 again. The network module 35 is disposed within or built in the image player 3 and electrically connected with the storage device 31. The network module 35 is accessible to a social website F in a wireless network communication manner. An image file P1 is stored in the social website F. The image file P1 is copied and then transmitted to the storage device 31 of the image player 3 to be stored through the network module 35. In an embodiment, the social website F is a Facebook social website, and the wireless network communication manner is a 3G wireless network communication manner, a 4G wireless network communication manner, a wireless fidelity (Wi-Fi) communication manner, a general packet radio service (GPRS) communication manner or an Edge network communication manner. After the image file P1 is transmitted from the social website F to the storage device 31, the image file P1 can be shown on the display screen 30 of the image player 3. In this way, people who do not or cannot access to the social website F can still watch the image file P1. In some embodiments, the network module 35 is in communication with the social website F in an Internet connection manner.

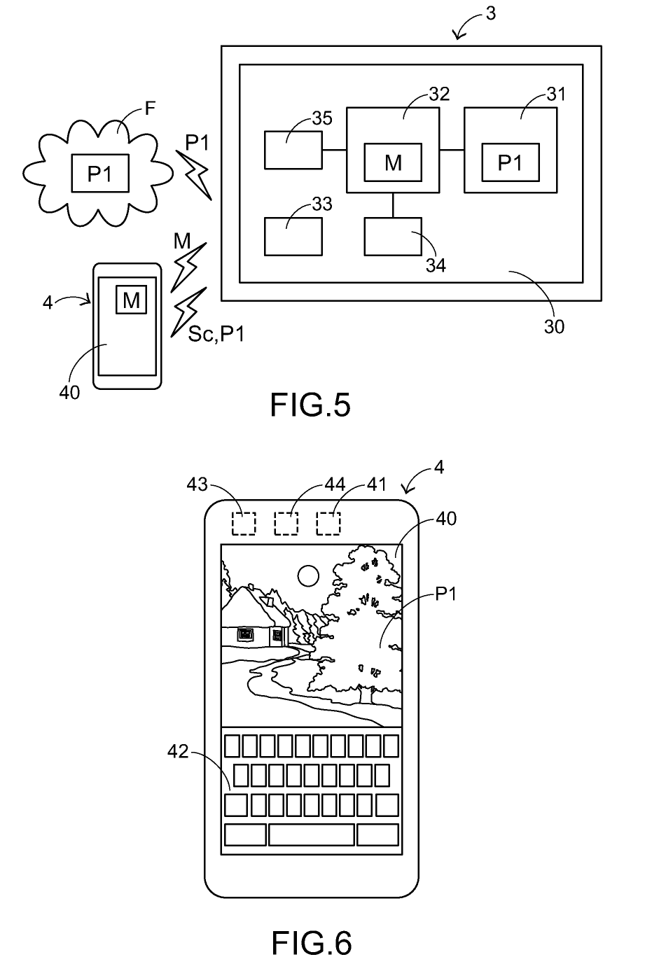

Please refer to FIGS. 5 and 6. FIG. 5 schematically illustrates the connection between the image player of the present invention and a handheld electronic device. FIG. 6 schematically illustrates a communication manner between the handheld electronic device and the image player according to an embodiment of the present invention. The handheld electronic device 4 as shown in FIG. 5 is owned by an observer passing through the image player 3. The wireless signal transmitter 33 of the image player 3 is disposed within the image player 3 for automatically issuing a wireless connection signal Sc to the handheld electronic device 4 in the vicinity of the image player 3 in order to establish connection between the image player 3 and the handheld electronic device 4. The term “automatically” used herein means the operation is not manually controlled. In this embodiment, the wireless signal transmitter 33 is a Bluetooth signal transmitter. In some embodiments, the wireless signal transmitter 33 is a near field communication (NFC) signal transmitter.

As shown in FIG. 6, the handheld electronic device 4 further comprises another display screen 40, another storage device 41, an input module 42, another wireless signal receiver 43 and another wireless signal transmitter 44. The storage device 41 is disposed within the handheld electronic device 4 for storing an image file. The display screen 40 is disposed on a surface of the handheld electronic device 4 for showing the image file that is stored in the storage device 41. The input module 42 is disposed on the surface of the handheld electronic device 4. Via the input module 42, the user may input characters or symbols as an evaluation message M (see FIG. 5). In this embodiment, the handheld electronic device 4 is a mobile phone, and the input module 42 is an on-screen keyboard shown on the display screen 40. In some embodiments, the input module 42 is a physical keyboard, which is arranged beside the display screen 40 and disposed on the surface of the handheld electronic device 4. The wireless signal receiver 43 is disposed within the handheld electronic device 4 for receiving the wireless connection signal Sc from the image player 3. The wireless signal transmitter 44 is disposed within the handheld electronic device 4 for transmitting the evaluation message M to the wireless signal receiver 34 of the image player 3. In this embodiment, the wireless signal transmitter 44 is a Bluetooth signal transmitter. Correspondingly, the wireless signal receiver 34 and the wireless signal receiver 43 are Bluetooth signal receivers. In some embodiments, the wireless signal transmitter 44 is a near field communication (NFC) signal transmitter. Correspondingly, the wireless signal receiver 34 and the wireless signal receiver 43 are near field communication (NFC) signal receivers.

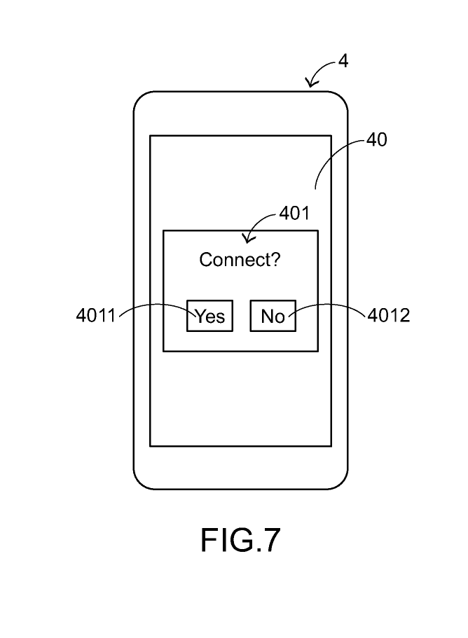

Hereinafter, the operations of the image player 3 will be illustrated with reference to FIGS. 5 and 7. FIG. 7 schematically illustrates the contents of a connection confirming interface of the handheld electronic device in communication with the image player according to an embodiment of the present invention. After the image player 3 is completely set up, the network module 35 of the image player 3 is in communication with the social website F in a wireless network communication manner. The image file P1 of the social website F is copied and then transmitted to the storage device 31 of the image player 3. Consequently, the image file P1 is shown on the display screen 30. Meanwhile, the wireless signal transmitter 33 of the image player 3 issues a wireless connection signal Sc. The receiving status of the wireless connection signal Sc may be used to judge whether any electronic device is in the vicinity of the image player 3. That is, if a user of the handheld electronic device 4 passes through the image player 3, the wireless connection signal Sc is issued from the wireless signal transmitter 33 of the image player 3 to the handheld electronic device 4 in the vicinity of the image player 3. When the wireless connection signal Sc from the wireless signal transmitter 33 is received by the handheld electronic device 4, a connection confirming interface 401 is shown on the display screen 40. Via the connection confirming interface 401, the user may determine whether the connection between the image player 3 and the handheld electronic device 4 will be established or not. As shown in FIG. 7, the connection confirming interface 401 includes a yes option 4011 and a no option 4012.

In a case that the yes option 4011 is activated by the user of the handheld electronic device 4, it means that the user agrees to establish the connection between the image player 3 and the handheld electronic device 4. After the connection between the image player 3 and the handheld electronic device 4 is established, the image file P1 issued from the wireless signal transmitter 33 of the image player 3 will be received by the wireless signal receiver 43 of the wireless signal transmitter 33 in a wireless transmission manner. Consequently, the image file P1 is shown on the display screen 40 (see FIG. 6). On the other hand, if the no option 4012 is activated by the user of the handheld electronic device 4, it means that the user refuses to establish the connection between the image player 3 and the handheld electronic device 4. Consequently, the connection confirming interface 401 is closed, and the connection between the image player 3 and the handheld electronic device 4 will not be established.

Please refer to FIG. 6 again. After the image file P1 is transmitted to the handheld electronic device 4 and stored in the storage device 41, the image file P1 and the input module 42 are shown on the display screen 40. Via the input module 42, the user of the handheld electronic device 4 may input characters or symbols as an evaluation message M. The evaluation message M is then transmitted from the wireless signal transmitter 44 of the handheld electronic device 4 to the wireless signal receiver 34 of the image player 3 in a wireless transmission manner. Please refer to FIG. 5 again. After the evaluation message M is received by the image player 3, the transfer program 32 is automatically executed to transfer the evaluation message M directly to the social website F through the network module 35 to have the evaluation message M posted on the social website F. Consequently, the evaluation message M associated with the image file P1 can be browsed by the users of the social website F.

From the above description, the image player of the present invention provides an input mechanism for the public. First of all, the image file of the social website can be acquired by the image player in a network communication manner. In addition, the connection between the image player and the handheld electronic device near the image player can be established in a wireless transmission manner. Consequently, the image file can be transmitted to the handheld electronic device to be watched by the user of the handheld electronic device. Then the user of the handheld electronic device may input an evaluation message through the input module of the handheld electronic device, and the evaluation message may be transmitted from the handheld electronic device to the image player in the wireless transmission manner. Moreover, the evaluation message may be transmitted from the image player to the social website in the network communication manner. Therefore, even if the image player has no input module, the evaluation message associated with the image file can still be generated via the input module of the handheld electronic device. Moreover, even if the handheld electronic device is not network-enabled, the image file can still be shown on the display screen of the handheld electronic device and the evaluation message can be inputted by the handheld electronic device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image player accessible to a social website, comprising:
a display screen, on which an image file revealed by the social website is shown;
a wireless signal transmitter disposed within image player and automatically issuing a wireless connection signal to a handheld electronic device in the vicinity of the image player in order to establish a connection between the image player and the handheld electronic device, wherein the image file is transmitted from the wireless signal transmitter to the handheld electronic device in a wireless transmission manner provided that the connection is successfully established;
a wireless signal receiver disposed within the image player for receiving an evaluation message regarding the image file from the handheld electronic device; and
a transfer program installed in the image player, and automatically executed to transfer the evaluation message received from the handheld electronic device to the social website.

2. The image player according to claim 1 further comprising a built-in storage device or a removable storage device for storing the image file.

3. The image player according to claim 2 wherein the removable storage device is a memory card or a memory device inserted in a connecting slot of the image player.

4. The image player according to claim 2 further comprising a built-in network module in communication with the storage device and accessible to the social website, wherein a copy of the image file revealed by the social website is duplicated and stored in the storage device.

5. The image player according to claim 4 wherein the built-in network module is accessible to the social website in a 3G wireless network communication manner, a 4G wireless network communication manner, a wireless fidelity (Wi-Fi) communication manner, a general packet radio service (GPRS) communication manner or an Edge network communication manner.

6. The image player according to claim 1 wherein the wireless signal transmitter is a Bluetooth signal transmitter or a near field communication (NFC) signal transmitter, and the wireless signal receiver is a Bluetooth signal receiver or a near field communication (NFC) signal receiver.

7. The image player according to claim 1, receiving an evaluation message regarding the image file from a handheld electronic device, which comprises:
a storage device for storing the image file transmitted from the image player;
a screen for showing the image file;
an input module for inputting characters or symbols as the evaluation message;
a wireless signal receiver for receiving the wireless connection signal from the image player; and
a wireless signal transmitter for transmitting the evaluation message to the wireless signal receiver of the image player.

8. The image player according to claim 7 wherein the input module is a physical keyboard arranged beside the screen, or an on-screen keyboard shown on the screen.

9. The image player according to claim 7 wherein when the wireless connection signal from the wireless signal transmitter is received by the handheld electronic device, a connection confirming interface is shown on the screen to optionally trigger the connection between the image player and the handheld electronic device.

10. The image player according to claim 9 wherein the connection confirming interface comprises a yes option to be selectively activated for permitting the connection, and a no option to be selectively activated for refusing the connection.

11. A method for evaluating an image file in a social website through an image player, the image file being shown on a display screen of an image player, the method comprising:
the image player automatically issuing a wireless connection signal to a handheld electronic device in the vicinity of the image player;
the image player automatically transmitting the image file to the handheld electronic device in a wireless transmission manner after the connection is successfully established;
the handheld electronic device transmitting an evaluation message regarding the image file to the image player; and
the image player automatically executing a transfer program to transfer the evaluation message to the social website.
